(19) United States
(12) Patent Application Publication
(10) Pub. No.: US 2023/0390949 A1
(43) Pub. Date: Dec. 7, 2023

(54) ADAPTABLE SUPPORT SYSTEM FOR GRASPING VARIABLE GEOMETRY STRUCTURES

(71) Applicant: THE BOEING COMPANY, Chicago, IL (US)

(72) Inventors: Luis VELASQUEZ, Ladson, SC (US); Matthew RAND, Arlington, VA (US)

(21) Appl. No.: 17/833,866

(22) Filed: Jun. 6, 2022

(51) Int. Cl. B25J 17/02; B25J 19/00; B25J 5/02; B25J 15/06; B64F 5/10

(52) U.S. Cl. CPC B25J 17/0275; B25J 19/0004; B25J 5/02; B25J 15/0616; B64F 5/10

(57) ABSTRACT

Certain aspects of the present disclosure provide techniques for an end effector system. The end effector system includes an end effector coupled to a gimbal assembly, wherein the end effector is configured to grasp an object and the gimbal assembly is attached to a shaft. The end effector system includes a first actuator coupled to the shaft and configured to move the shaft and a self-alignment assembly. The self-alignment assembly includes a first surface coupled to the end effector and a second surface coupled to the first actuator and configured to interface with the first surface, wherein the first actuator is configured to move the shaft such that the first surface engages the second surface to position the gimbal assembly at a first position.

### INTRODUCTION

### Field

Aspects of the present disclosure relate to a system for grasping an object.

### BACKGROUND

Movement of objects, such as parts and material, is an important part of production and assembly processes. Conventional systems and methods for moving objects are limited in their capability or may not be suitable for certain production processes, such as moving large objects or objects having complex geometry or shape. Keeping with this example, the large or complex objects may be moved using manual or automated handling. Manual handling includes moving the materials with an operator or operators, which is a cumbersome process that may damage the material. Automated handling includes robotic systems with an end effector. However, the robotic systems are limited in the size and shape objects of they can move, and may require reconfiguration for each object that is moved. Multiple robotic systems may be required for moving large or complex objects. Further, robotic systems are not suitable for moving delicate material because the end effector may damage the material by exerting a force on the material that is higher than the force the material can withstand.

Accordingly, there is a need for an improved system for moving objects that can grasp and move large objects or objects having complex shapes without damaging the objects.

### BRIEF SUMMARY

Certain embodiments provide an end effector system. The end effector system includes an end effector coupled to a gimbal assembly. The end effector is configured to grasp an object. The gimbal assembly is attached to a shaft. The end effector system further includes a first actuator coupled to the shaft and configured to move the shaft. The end effector system further includes a self-alignment assembly. The self-alignment assembly includes a first surface coupled to the end effector and a second surface coupled to the first actuator and configured to interface with the first surface. The first actuator is configured to move the shaft such that the first surface engages the second surface to position the gimbal assembly at a first position.

Other embodiments provide a stringer placement system. The stringer placement system includes a plurality of end effectors supported along a support structure. The support structure includes a plurality of longitudinal stiffeners. Each respective longitudinal stiffener of the plurality of longitudinal stiffeners includes a lower circumferential guide track and a rack gear. The support structure further includes a gimbal assembly coupled to each respective end effector of the plurality of end effectors. The gimbal assembly is configured to allow the respective end effector to rotate about at least one axis. The stringer placement system further includes a radial actuation system coupled to the respective end effector. The radial actuation system includes a radial actuator. The radial actuator is configured to move the respective end effector in a direction orthogonal to a respective longitudinal stiffener. The stringer placement system further includes a circumferential actuation system coupled to the respective end effector. The circumferential actuation system includes a circumferential actuator coupled to a pinion gear. The pinion gear is configured to engage the rack gear of the respective longitudinal stiffener to move the respective end effector along the respective longitudinal stiffener. The stringer placement system further includes a lower carriage assembly configured to movably attach the radial actuation system and the circumferential actuation system to the lower circumferential guide track of the respective longitudinal stiffener.

Other embodiments provide a method of grasping an object using an end effector. The method includes moving an end effector system along a circumferential guide track of a longitudinal stiffener using a first actuator. The end effector system includes the end effector coupled to a gimbal assembly. The end effector is configured to grasp an object. The gimbal assembly is attached to a shaft. The end effector system further includes a second actuator coupled to the shaft. The second actuator is configured to move the shaft. The end effector system further includes a self-alignment assembly. The self-alignment assembly includes a first surface coupled to the end effector and a second surface coupled to the second actuator and configured to interface with the first surface. The method further includes moving the end effector in a direction perpendicular to the longitudinal stiffener such that the end effector contacts the object and rotates about an axis of the gimbal assembly. The method further includes grasping the object with the end effector.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIGS. 1A-1C depict side views of stringer placement systems mounted in different configurations, according to some embodiments.

FIG. 2 depicts a trimetric view of a stringer placement system, according to some embodiments.

FIGS. 3A-3I depict different views of a stringer placement system having an end effector system, according to some embodiments.

FIG. 3J depicts a cross-sectional view of an end effector system in a retracted position, according to some embodiments.

FIGS. 3K and 3L depict cross-sectional views of the end effector from FIG. 3H, according to some embodiments.

FIGS. 4A-4D depict different views of a stringer placement system, according to some embodiments.

FIGS. 5A-5C depict a bottom view of different gimbal lock mechanisms, according to some embodiments.

FIG. 6 depicts an example method for aligning a plurality of end effectors of a support structure, according to some embodiments.

FIG. 7 depicts a schematic view of an example system controller that can be used according to the systems and methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In the following description, details are set forth by way of example to facilitate an understanding of the disclosed subject matter. It should be apparent to a person of ordinary skill in the field, however, that the disclosed implementations are exemplary and not exhaustive of all possible implementations. Thus, it should be understood that reference to the described examples is not intended to limit the scope of the disclosure. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Aspects of the present disclosure provide a system for grasping and moving objects, such as a material or part, without damaging the objects.

Typically, objects may be moved using manual or automated handling. For example, pick and place of materials, such as a stringer or longeron of an aircraft, which may be a pre-cured composite, may be done through manual handling. An operator or multiple operators if the stringer is large, will carefully pick up the stringer and transport the stringer to a different location, such as to an aircraft structure for installation. However, manual handling is a slow process, requires human operators, and can damage the stringer if the stringer is not handled carefully.

Automated handling may also be used to pick and place the stringer, but is limited in application because of the size and shape of the stringer. For example, the stringer may span across several formers or bulkheads. The formers may vary in size and shape depending on their location on the aircraft. As a result, the stringer may follow a curved path across the formers and the automated handling must be adjusted to properly place the stringer along the curved path. Automated handling may also be incapable of moving more than one stringer at a time. Thus, automated handling may not be used to place objects such as stringers, or may only be used in limited applications.

The adaptable support system described herein addresses these issues by using adjustable end effectors having a gimbal assembly and an alignment system. A position of each end effector can be adjusted to account for variable geometry of shaped objects, resulting in a universal design that can manipulate a wide variety of objects that formerly required manual manipulation. This in-turn leads to faster, safer, and more precise object placement, improving the production process and quality of the end product alike.

### Examples of Stringer Placement Systems

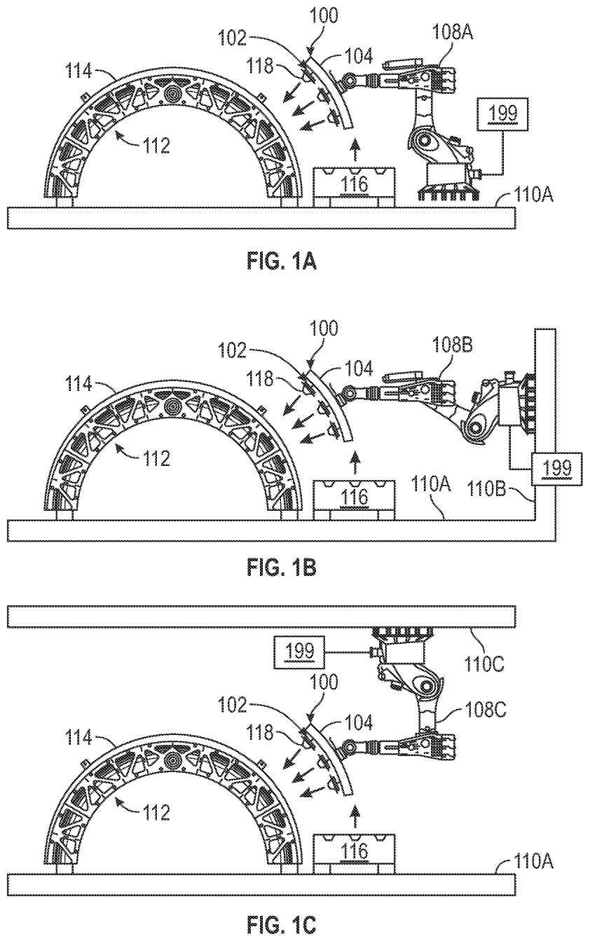

FIGS. 1A-1C depict schematic views of a stringer placement system 100 mounted in different configurations, according to some embodiments. In particular, FIG. 1A shows the stringer placement system 100 (referred to as the system 100), mounted to a motion system, such as a robotic arm 108A. The robotic arm 108A is mounted to a floor 110A. The system 100 comprises an end effector system 102 coupled to a support structure 104. In some embodiments, the support structure 104 may be referred to as a strongback.

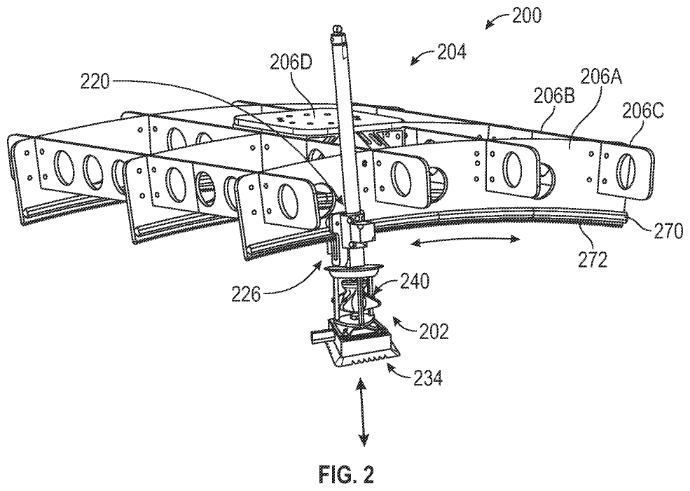

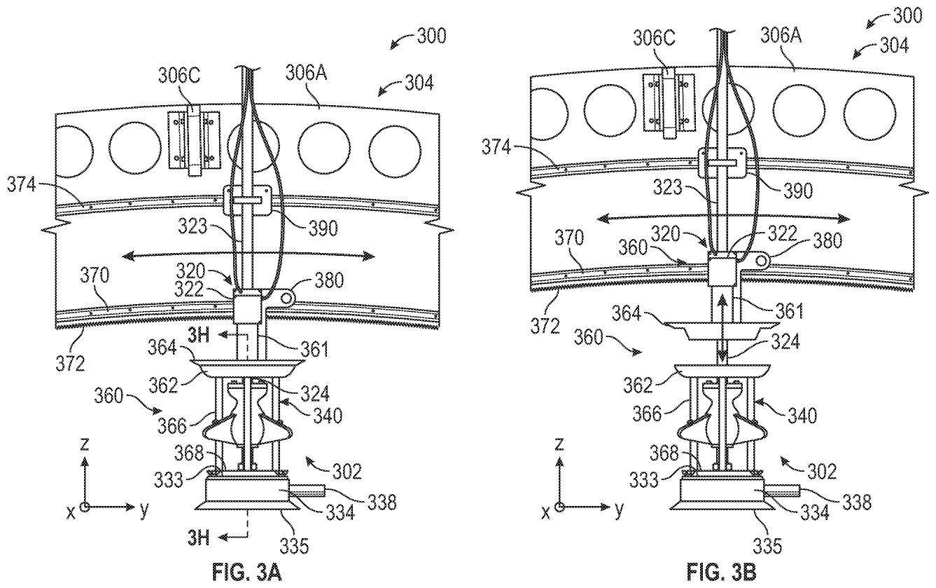

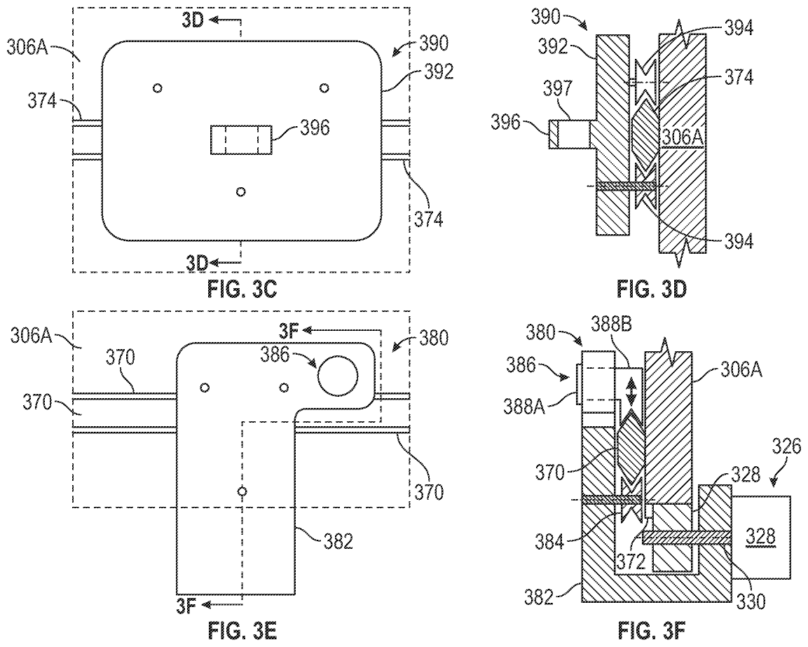

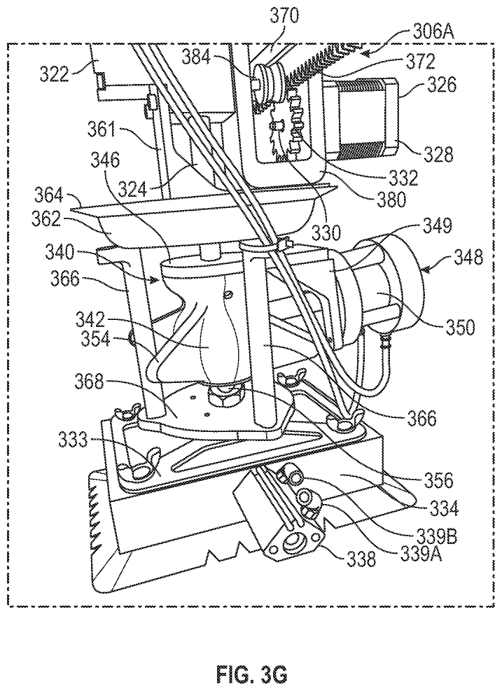

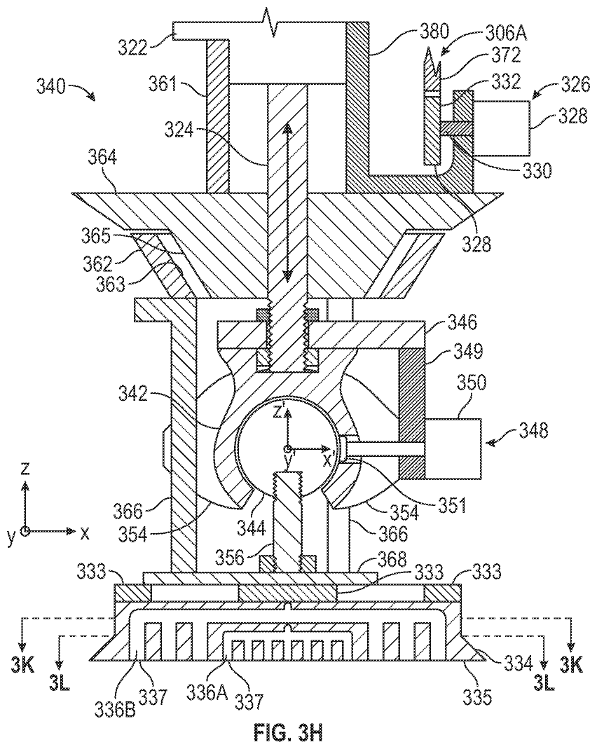

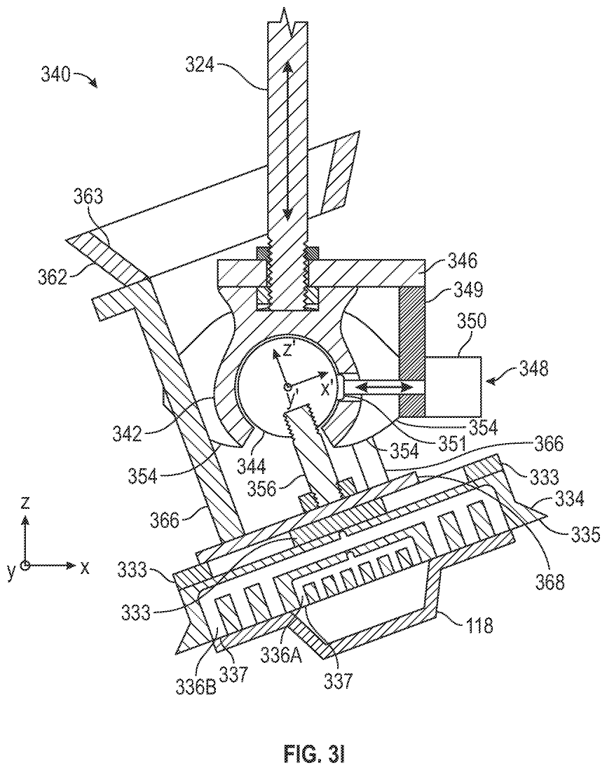

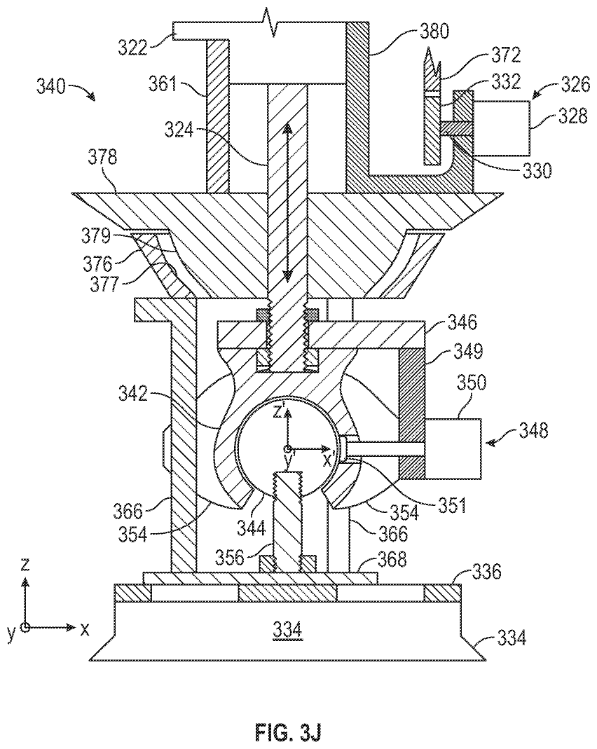

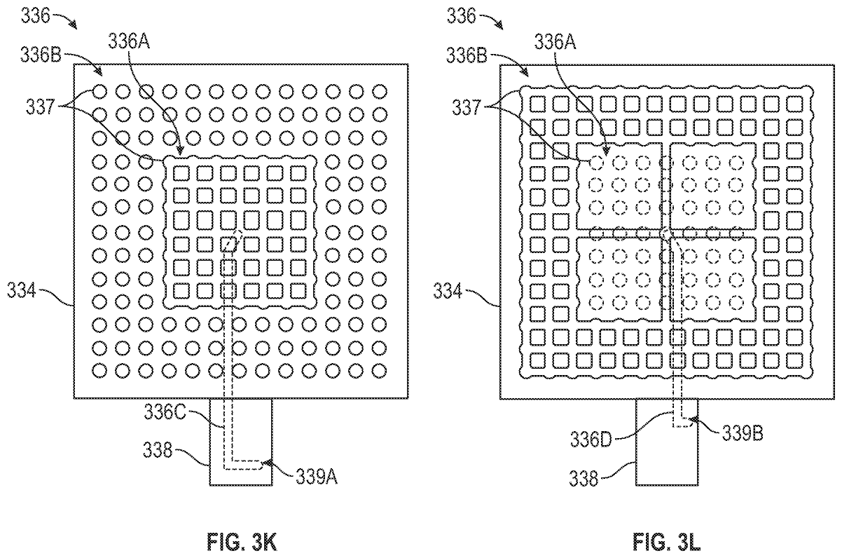

The system 100 may pick up a plurality of stringers 118 from a staging tray 116 using the end effector system 102. Each end effector system 102 may extend toward the stringers 118 to grasp the stringers 118, as described in relation to FIGS. 2 and 3A-3J. The robotic arm 108A then moves the system 100 and the grasped stringers 118 near an airframe 114, where the end effector system 102 extends the stringers 118 to place the stringers 118 for installation on to the airframe 114. In the depicted embodiment, the stringers 118 are installed on the airframe 114 while the airframe 114 is coupled to a curing tool 112.

The support structure 104 may be a radial structure that follows a shape of the airframe 114, but in other embodiments, the support structure 104 may not be curved or may be shaped to a match a different profile.

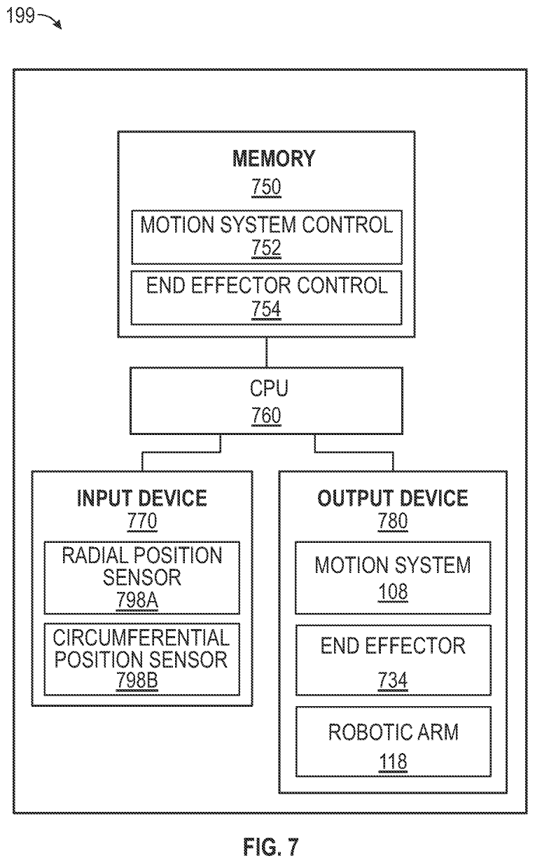

A controller 199 may control the system 100 as described in relation to FIG. 7. For example, the controller 199 may move the robotic arm 108A to place the stringers 118 in a desired location on the airframe 114.

FIG. 1B shows the system 100 mounted to a robotic arm 108B. The robotic arm 108B is similar to the robotic arm 108A discussed in relation to FIG. 1A, except the robotic arm 108B is mounted to a wall 110B.

FIG. 1C shows the system 100 mounted to a robotic arm 108C. The robotic arm 108C is similar to the robotic arm 108A discussed in relation to FIG. 1A, except the robotic arm 108C is mounted to a ceiling 110C.

FIG. 2 depicts a trimetric view of a stringer placement system 200, according to some embodiments.

The stringer placement system 200 (referred to as the system 200) includes a plurality of end effector systems 202 (one of which is shown) coupled to a support structure 204. The support structure 204 includes longitudinal stiffeners 206A, ribs 206B, rib ends 206C, and a support structure mount plate 206D. The support structure 204 is arranged such that the ribs 206B are orthogonal to (e.g., substantially perpendicular to) the longitudinal stiffeners 206A and are coupled to the longitudinal stiffeners 206A. The substantially perpendicular arrangement of the ribs 206B to the longitudinal stiffeners 206A may ensure the support structure 204 is structurally sound enough to handle shear, torsion, and bending loads. In some embodiments, substantially perpendicular means 90 degrees within +/−3 degrees, or within +/−2 degrees, or within +/−1 degree.

The rib ends 206C are coupled to outer sides of the outermost longitudinal stiffeners 206A, and are positioned in-line with the ribs 206B. In some embodiments, the rib ends 206C are part of the ribs 206B. The ribs 206B and rib ends 206C may be coupled to the longitudinal stiffeners 206A through brackets and fasteners, such as bolts and nuts, screws, anchors, and rivets, or through welding or adhesive. In some embodiments, a lap joint, such as a cross lap joint, may be used to couple the ribs 206B and rib ends 206C to the longitudinal stiffeners 206A. The support structure mount plate 206D is coupled to the support structure 204 and is configured to mount the support structure 204 to the motion system discussed in relation to FIGS. 1A-1C (e.g., the robotic arm 108). The support structure mount plate 206D may be coupled to the longitudinal stiffeners 206A or to the longitudinal stiffeners 206A and the ribs 206B.

A gimbal assembly 240 is coupled to each end effector 234 and allows the end effector 234 to rotate about at least one axis, as further described in relation to FIG. 3I. A radial actuation system 220 may move the end effector 234 in a direction perpendicular to (e.g., towards and away from) the longitudinal stiffener 206A, which allows the end effector 234 to grasp objects (e.g., the stringer 118 in FIGS. 1A-1C) located at different distances from the end effector system 202.

A circumferential actuation system 226 is coupled to the end effector 334 and may move the end effector system 202 along a length of the longitudinal stiffener 206A. In the depicted embodiment, the circumferential actuation system 226 engages a rack gear 272 of the longitudinal stiffener 206A to move along a circumferential guide track 270 of the longitudinal stiffener 206A. The rib ends 206C and/or ribs 206B may limit the motion range of the circumferential actuation system 226 since part of the radial actuation system 220 may extend between the rib ends 206C and/or the ribs 206B. Thus, several end effector systems 202 may be used per each longitudinal stiffener 206A, such as one end effector system 202 between each rib end 206C and/or rib 206B.

In some embodiments, the system 200 may not comprise the rib ends 206C. In such embodiments, the motion range of the circumferential actuation system 226 may span the length of the longitudinal stiffener 206A. For example, one end effector system 202 and circumferential actuation system 226 may be used per each longitudinal stiffener 206A. Several end effector systems 202 may be used per longitudinal stiffener 206A. The controller 199 (in FIG. 1A-1C) may be used to prevent the several end effector systems 202 from colliding.

In some embodiments, the system 200 may not comprise ribs 206B or rib ends 206C. In some embodiments, the longitudinal stiffeners 206A may mount directly to the motion system (e.g., the robotic arm 108 in FIGS. 1A-1C).

FIGS. 3A-3I depict different views of a stringer placement system 300 having an end effector system 302, according to some embodiments.

FIGS. 3A and 3B depict a side view of the stringer placement system 300 with the end effector system 302 in a retracted and extended positon, respectively, according to some embodiments.

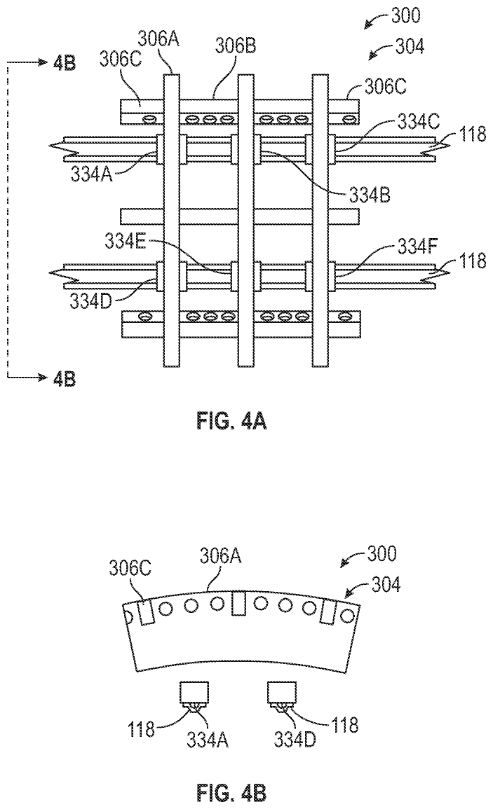

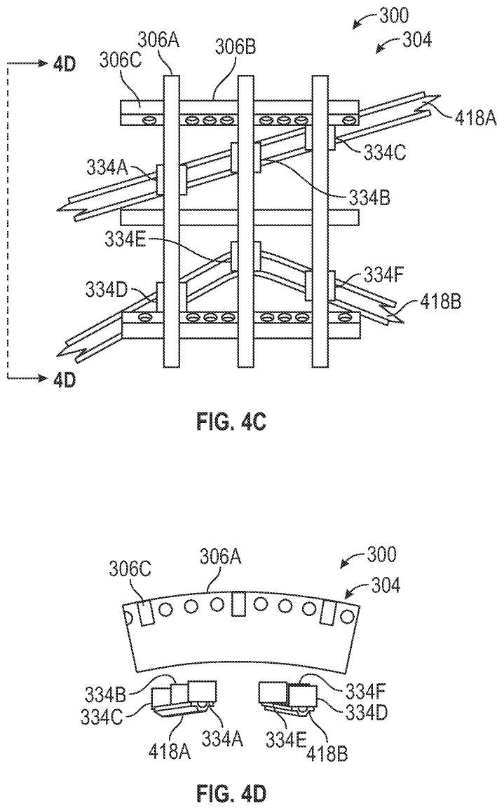

The stringer placement system 300 (referred to as the system 300) includes a plurality of end effector systems 302 (one of which is shown) coupled to a support structure 304. The support structure 304 includes longitudinal stiffeners 306A (one of which is shown), ribs (e.g., ribs 306B in FIGS. 4A and 4C), rib ends 306C, and a support structure mount plate (not shown). The system 300 further includes an upper circumferential guide track 374, a lower circumferential guide track 370, and a rack gear 372. The tracks 370 and 374 are coupled to the longitudinal stiffeners 306A through fasteners, such as bolts and nuts, screws, anchors, and rivets. The tracks 370 and 374 may be coupled to a side or face of the longitudinal stiffeners 306A that is positioned parallel to a bulkhead or former of an airframe (e.g., the airframe 114 in FIG. 1) when used to place stringers (e.g., the stringers 118 in FIG. 1) for installation on to the airframe. The rack gear 372 is integrally formed with the longitudinal stiffeners 306A on a side of the longitudinal stiffeners 306A that is closest to the end effector 334. For example, the rack gear 372 may be machined out of, welded to or bonded to, or otherwise joined to the longitudinal stiffeners 306A to function as a single article.

The end effector system 302 includes a gimbal assembly 340, an end effector 334, and a self-alignment assembly 360. The self-alignment assembly 360 is used to align the end effector system 302 before or after use. The self-alignment assembly 360 includes a first alignment feature, such as a self-alignment mechanism cup 362, coupled to the end effector 334. The self-alignment mechanism cup 362 is coupled to the end effector 334 through a plurality of self-alignment mechanism support legs 366 (referred to as the support legs 366). In the embodiment depicted in FIGS. 3A and 3B, the support legs 366 connect to a self-alignment mechanism mount plate 368 (referred to as the mount plate 368), which connects to an end effector plate 333, which connects to the end effector 334. The support legs 366, mount plate 368, end effector plate 333, and end effector 334 may each connect through fasteners, welding, or adhesive, or be integrally formed, as described in relation to the tracks 370 and 374, rack gear 372, and longitudinal stiffeners 306A. In some embodiments, the self-alignment assembly 360 may be referred to as a self-centering assembly.

The self-alignment assembly 360 further includes a second alignment feature, such as a self-alignment mechanism cone 364. A radial actuation system 320 moves the self-alignment mechanism cup 362 in relation to the self-alignment mechanism cone 364 as described below. The self-alignment mechanism cup 362 is coupled to the radial actuation system 320 through the gimbal assembly 340. The self-alignment mechanism cup 362 aligns the end effector system 302 to a first position when it contacts the self-alignment mechanism cone 364, as further described in relation to FIGS. 3H and 3I.

The end effector system 302 is movably coupled to the system 300 through a lower carriage assembly 380 and an upper carriage assembly 390. The lower carriage assembly 380 is movably coupled to the lower guide track 370 and the upper carriage assembly 390 is movably coupled to the upper guide track 374 as further discussed in relation to FIGS. 3C-3G. The self-alignment mechanism cone 364 is coupled to the lower carriage assembly 380 thorough a cone mount bracket 361. In some embodiments, the cone mount bracket 361 may be coupled directly to the lower carriage assembly 380. In some embodiments, the lower and upper carriage assemblies 380 and 390 may be referred to as truck assemblies.

A circumferential actuation system 326 is coupled to the lower carriage assembly 380. The circumferential actuation system 326 moves the end effector system 302 along at least a portion of the length of the longitudinal stiffeners 306A, such as along the guide tracks 370 and 374. For example, the circumferential actuation system 326 may be used to position the end effector system 302 over an object to be grasped. The circumferential actuation system 326 is further discussed in relation to FIGS. 3C-3G.

A radial actuation system 320 includes a radial actuator 322 and a shaft 324. The radial actuator 322 moves the shaft 324, which is coupled to the lower carriage assembly 380. In some embodiments, the radial actuation system 320 may be coupled to the upper carriage assembly 390. The radial actuation system 320 moves with the circumferential actuation system 326. The shaft 324 is disposed inside an actuator cylinder 323 of the radial actuator 322 and is coupled to the end effector system 302, such as to the gimbal assembly 340. Thus, the radial actuation system 320 is coupled to the end effector 334 in the depicted embodiment. The shaft 324 is further disposed through the self-alignment mechanism cone 364. The cone mount bracket 361 may be fastened to the self-alignment mechanism cone 364 and to the radial actuator 322 using fasteners, but may also be coupled through welding, adhesive, or other means.

The radial actuator 322 moves the gimbal assembly 340, end effector 334, and the self-alignment mechanism cup 362 toward and away from the longitudinal stiffener 306A by moving the shaft 324. The radial actuator 322 moves the shaft 324 linearly in relation to the self-alignment mechanism cone 364 and in relation to the longitudinal stiffeners 306A. In some embodiments, the radial actuation system 320 may be used to move the end effector system 302 in a direction perpendicular to the movement of the circumferential actuation system 326. In some embodiments, the radial actuation system 320 moves the end effector system 302 in a direction that is perpendicular to at least one of the guide tracks 370 and 374. The radial actuator 322 may be a linear actuator, such as a mechanical or electro mechanical, hydraulic, pneumatic, or piezoelectric linear actuator, to name a few options.

In the embodiment depicted in FIG. 3A, the radial actuator 322 is a hydraulic linear actuator and two hydraulic lines (not labeled) are shown connecting to the gimbal lock actuator 350. The hydraulic lines supply a hydraulic fluid, which moves the shaft 324. In some embodiments, the radial actuator 322 is a pneumatic linear actuator the lines are pneumatic lines that supply a gas or compressed gas (e.g., air, inert gas, or nitrogen).

The end effector system 302 uses the end effector 334 to grasp objects. A grasping surface 335 of the end effector 334 is used to grasp the objects. When grasping an object (e.g., the stringer 118), the grasping surface 335 is positioned adjacent to the object to be grasped. In the embodiments depicted in FIGS. 3A-3L, the end effector 334 connects to a vacuum source (not shown), such as a vacuum pump or other device that generates a vacuum, and uses an underpressure or vacuum (e.g., suction) to grasp objects. A vacuum manifold 338 connects the end effector 334 to the vacuum source. The vacuum manifold 338 is coupled to a side of the end effector 334. The end effector 334 is coupled to the gimbal assembly 340, which allows the end effector 334 to change orientation. The end effector 334 may rotate about an axis of the gimbal assembly 340 when extended away from the longitudinal stiffeners 306A, such as described in relation to FIGS. 3H and 3I, to grasp objects at different angles.

In some embodiments, when the grasping surface 335 of the end effector 334 contacts the object to be grasped, the contact with the object changes the orientation of the end effector system 302 such that at least a portion of the grasping surface 335 is parallel to a surface of the object to be grasped. The grasping surface 335 is a surface of the end effector 334 that is furthest from the longitudinal stiffener 306A. The end effector 334 is in a second position when the end effector 334 grasps the object.

The controller 199 (FIGS. 1A-1C) may be used to control the system 300. The controller 199 may control the radial actuator 322, and in particular, the movement or actuation of the shaft 324. The controller 199 may control the circumferential actuator 328, and in particular, the rotation of the pinion gear 332. The controller 199 may control the end effector 334, such as the underpressure or vacuum of the end effector 334, by controlling a pressure of the vacuum source.

In some embodiments, the rack gear 372 may be coupled to the longitudinal stiffeners 306A through fasteners. In some embodiments, the tracks 370 and 374 may be integrally formed with the longitudinal stiffeners 306A. In some embodiments, the tracks 370 and 374 and/or rack gear 372 may be welded to the longitudinal stiffeners 306A or bonded using an adhesive. Coupling the tracks 370 and 374 and/or rack gear 372 to the longitudinal stiffeners 306A using fasteners beneficially allows replacement of at least a portion of the tracks 370 and 374 and/or rack gear 372, for example, if there is excessive wear or damage.

In the embodiment depicted in FIGS. 3A and 3B, the tracks 370 and 374 and the rack gear 372 are arc-shaped. In some embodiments, the tracks 370 and 374 and/or the rack gear 372 are not arc-shaped. For example, the tracks 370 and 374 and/or the rack gear 372 may be linear or straight and extend between the ribs 306B and/or the rib ends 306C. The linear geometry may be easier and cheaper to manufacture than the arc-shaped geometry.

In the depicted embodiment, the movement of the end effector system 302 along the tracks 370 and 374 is limited by the ribs 306B and/or the rib ends 306C. The actuator cylinder 323 of the radial actuator 322 would collide or interfere with the ribs 306B and/or the rib ends 306C (depending on the longitudinal stiffener 306A in question) if the circumferential actuation system 326 were to move the end effector system 302 along the entire length of the longitudinal stiffener 306A. In some embodiments, the circumferential actuation system 326 moves the end effector system 302 along an entire length of the longitudinal stiffener 306A. In some embodiments, the actuator cylinder 323 does not extend beyond the ribs 306B and/or the rib ends 306C, at least when the end effector system 302 is extended, such that the radial actuator 322 would not collide or interfere with the ribs 306B and/or the rib ends 306C when the end effector system 302 is moved along the length of the longitudinal stiffener 306A.

In some embodiments, the radial actuator 322 moves the shaft 324 through the radial actuator 322 to move the end effector 334. In such embodiments, what is shown as the actuator cylinder 323 in FIGS. 2 and 3A-3B may be the shaft 324. In some embodiments, the radial actuator 322 includes a pinion gear to engage a rack gear of the shaft 324 when moving the shaft 324 through the radial actuator 322. In such embodiments, the radial actuator 322 rotates the pinion gear 332 to linearly move the shaft 324 via the rack gear of the shaft 324.

In some embodiments, the self-alignment mechanism support legs 366 may be integrally formed with the mount plate 368. In some embodiments, the self-alignment mechanism support legs 366 may connect directly to the end effector 334 using fasteners, welding, adhesive or be integrally formed with the end effector 334. In some embodiments, the end effector plate 333 is not used and the mount plate 368 directly couples to the end effector 334.

FIGS. 3C and 3D depict a side and cross-sectional view of the upper carriage assembly 390, according to some embodiments. In particular, FIGS. 3C and 3D show the upper carriage assembly 390 coupled to the longitudinal stiffener 306A and are herein described together for clarity.

The upper carriage assembly 390 includes an upper carriage 392, upper carriage rollers 394, and a cylinder mount 396. The upper carriage 392 may be a plate and is generally parallel to the longitudinal stiffener 306A. The cylinder mount 396 may be coupled to or integrally formed with the upper carriage 392 and protrude orthogonal to (e.g., normal to or substantially perpendicular to) the upper carriage 392. In some embodiments, the cylinder mount 396 protrudes 90 degrees from the upper carriage 392, within +/−5 degrees, within +/−3 degrees, or within +/−1 degrees. The cylinder mount 396 forms an upper carriage opening 397 through which the actuator cylinder 323 (FIG. 3A) is disposed. Thus, the radial actuation system 320 is coupled to the upper carriage assembly 390 through the cylinder mount 396.

The upper carriage rollers 394 are rotatably coupled to the upper carriage assembly 390 through a shaft (not labeled) and bearings (not shown) to allow the upper carriage rollers 394 to rotate freely. The upper carriage rollers 394 travel along the upper circumferential guide track 374 and are shaped to complement the upper circumferential guide track 374. In the depicted embodiment, the upper circumferential guide track 374 has a triangular protrusion on sides that engage the upper carriage rollers 394 (e.g., an upper side and a lower side opposite the upper side). The upper carriage rollers 394 include a v-shaped notch that engages the triangular protrusions of the upper circumferential guide track 374.

FIGS. 3E and 3F depict a side and cross-sectional view of the lower carriage assembly 380, according to some embodiments. In particular, FIGS. 3E and 3F show the lower carriage assembly 380 coupled to the longitudinal stiffener 306A and are herein described together for clarity.

The lower carriage assembly 380 includes a lower carriage 382, lower carriage rollers 384, and a lower carriage brake assembly 386. The lower carriage rollers 384 are rotatably coupled to the lower carriage 382. The lower carriage assembly 380 uses the lower carriage rollers 384 to move on the lower circumferential guide track 370 similar to how the upper carriage assembly 390 moves on the upper circumferential guide track 374. For example, the lower carriage rollers 384 are shaped to complement a shape of the lower circumferential guide track 370. The lower carriage brake assembly 386 includes a lower carriage lock actuator 388A and a lower carriage lock mechanism 388B. The lower carriage lock actuator 388A moves the lower carriage lock mechanism 388B towards and away from the lower circumferential guide track 370 and may be any suitable linear or rotary actuator. The lower carriage lock mechanism 388B engages the lower circumferential guide track 370 to temporarily lock or fix the end effector system 302 at a position along the longitudinal stiffener 306A, or otherwise prevent the end effector system 302 from moving along the lower circumferential guide track 370. In some embodiments, the lower carriage lock mechanism 388B uses friction to hold the position of the longitudinal stiffener 306A. In some embodiments, the lower carriage lock mechanism 388B uses magnetism to hold the position. In such embodiments, the lower carriage lock mechanism 388B may be an electromagnet or permanent magnet and lower circumferential guide track 370 includes a magnetic material or coating (e.g. iron, steel, nickel, or cobalt).

The circumferential actuation system 326 includes a circumferential actuator 328, a circumferential actuator shaft 330, and a pinion gear 332. The circumferential actuator 328 may be a rotary actuator such as a servo or servomotor, stepper motor, rack-and-pinion actuator, a vane actuator, a helix actuator, a planetary actuator, a linear cylinder, a scotch-yoke actuator, a sprocket actuator, a bladder actuator, a direct-drive motor, and the like. The circumferential actuation system 326 is coupled to the lower carriage assembly 380. For example, the circumferential actuator 328 is coupled to the lower carriage assembly 380 through fasteners, welding, or adhesive. The pinion gear 332 is coupled to the circumferential actuator 328 through a shaft (not labeled). The circumferential actuator 328 rotates the shaft to rotate the pinion gear 332, engage the rack gear 372, and move the end effector system 302 along the tracks 370 and 374.

In the depicted embodiment, the upper carriage rollers 394 engage opposite sides of the upper circumferential guide track 374, which beneficially secures the upper carriage assembly 390 to the longitudinal stiffener 306A and limits or prevents lateral movement (e.g., movement orthogonal, normal, or substantially perpendicular to the longitudinal stiffener 306A) of the upper carriage assembly 390. The lower carriage rollers 384 similarly engage opposite sides of the lower circumferential guide track 370. In some embodiments, the rollers 384 and 394 travel along only one side (e.g., an upper side or a lower side) of the tracks 370 and 374, which beneficially reduces the amount of moving parts in the system 300.

### Examples of End Effector Systems

FIG. 3G depicts a trimetric view of the end effector system 302, according to some embodiments.

In particular, FIG. 3G shows how the end effector system 302 is coupled to the longitudinal stiffener 306A. As discussed in relation to FIGS. 3E and 3F, the circumferential actuator 328 rotates the pinion gear 332, which engages the rack gear 372, which moves the end effector system 302 along the lower circumferential guide track 370 and the upper circumferential guide track 374 (FIG. 3D).

The gimbal assembly 340 includes a gimbal housing 342, a gimbal ball 344 (FIGS. 3H and 3I), a gimbal plate 346, and a gimbal lock assembly 348. The gimbal housing 342 includes position limiters 354 (sometimes referred to as “wings”), which may be fastened to, welded to, adhered to, or integrally formed with the gimbal housing 342. The position limiters 354 engage the support legs 366 and limit rotation of the gimbal assembly 340 as described in relation to FIGS. 3H and 3I.

The gimbal lock assembly 348 engages the gimbal ball 344 to temporarily lock or fix the end effector system 302 at the second position. The gimbal lock assembly 348 includes a gimbal lock actuator 350. In the embodiment depicted in FIG. 3G, the gimbal lock actuator 350 is a hydraulic linear actuator and two hydraulic lines (not labeled) are shown connecting to the gimbal lock actuator 350. The hydraulic lines supply a hydraulic fluid, which moves a shaft (not labeled) of the actuator towards and away from the gimbal housing 342. In some embodiments, the gimbal lock actuator 350 is a pneumatic linear actuator the lines are pneumatic lines that supply a gas or compressed gas (e.g., air, inert gas, or nitrogen). The gimbal assembly 340 and the gimbal lock assembly 348 are further discussed in relation to FIGS. 3H and 3I.

The vacuum manifold 338 includes a first vacuum port 339A and a second vacuum port 339B. The first and second vacuum ports 339A and 339B are coupled to channels 336 formed in the end effector 334 as discussed in relation to FIGS. 3H and 3I. The first and second vacuum ports 339A and 339B further connect to the vacuum source discussed in relation to FIGS. 3A and 3B.

FIGS. 3H and 3I depict cross-sectional views of the end effector system 302 from FIG. 3A in a retracted and extended position, respectively, according to some embodiments. The gimbal ball 344 and parts of the circumferential actuation system 326 and gimbal lock assembly 348 are not shown as cross-hatched in FIGS. 3H and 3I for simplification of illustration.

The shaft 324 couples to the gimbal assembly 340 through the gimbal plate 346, which couples to an upper surface of the gimbal housing 342. In the embodiment depicted in FIGS. 3H and 3I, a bolt is positioned on each side of the gimbal plate 346. The shaft 324 threads into each of the bolts and secures the gimbal plate 346 in between. The gimbal plate 346 is fastened, welded, or adhered to the upper surface of the gimbal housing 342. The bolt positioned in between the gimbal plate 346 and the gimbal housing 342 may engage the gimbal housing 342 to constrain rotation about the shaft 324 and prevent loosing or unthreading.

The gimbal ball 344 is spherical in shape and is disposed inside the gimbal housing 342. A gimbal transfer shaft 356 couples the gimbal ball 344 to the end effector 334 through the mount plate 368. For example, the gimbal housing 342 forms an opening at a lower end to allow access to the gimbal ball 344. The gimbal transfer shaft 356 threads into the gimbal ball 344 at a first end and into the mount plate 368 at a second end opposite the first end. The gimbal ball 344 may rotate freely inside the gimbal housing 342. A coordinate system of the gimbal ball 344 (e.g., x′, y′, and z′) rotates in relation to a coordinate system of the system 300 (e.g., x, y, and z). The gimbal lock actuator 350 is coupled to the gimbal assembly 340 through a gimbal lock plate 349. The gimbal lock plate 349 is coupled to the gimbal plate 346. The gimbal lock plate 349 forms an opening through which a shaft (not labeled) of the gimbal lock actuator 350 is disposed. The gimbal lock mechanism 351 is coupled to the shaft of the gimbal lock actuator 350 and is disposed in an opening (not labeled) in a side of the gimbal housing 342. The gimbal lock actuator 350 may move the gimbal lock mechanism 351 through the opening in the gimbal housing 342 and towards and away from the gimbal ball 344. The gimbal lock mechanism 351 may contact or engage the gimbal ball 344, such as shown in FIG. 3I, to fix an orientation and position of the gimbal ball 344 and prevent the end effector 334 from moving in relation to the rest of the end effector system 302. The gimbal lock plate 349 is orthogonal to (e.g., normal to or substantially perpendicular to) the gimbal plate 346, which ensures the gimbal lock actuator 350 moves the gimbal lock mechanism 351 in a direction perpendicular to the gimbal plate 346. In some embodiments, the gimbal lock plate 349 is 90 degrees to the gimbal plate 346, within +/−5 degrees, within +/−3 degrees, or within +/−1 degrees.

Thus, the end effector system 302 includes two sub-portions in the depicted embodiment: one sub-portion that remains fixed (e.g., a fixed sub-portion) and one that moves in relation to the fixed sub-portion (e.g., a movable sub-portion). The movable sub-portion includes the self-alignment mechanism cup 362, support legs 366, mount plate 368, end effector plate 333, end effector 334, vacuum manifold 338 (FIG. 3G), gimbal transfer shaft 356, and gimbal ball 344, which rotate together in relation to the fixed sub-portion. The fixed sub-portion includes the gimbal housing 342, gimbal lock assembly 348, shaft 324, self-alignment mechanism cone 364, and rest of the end effector system 302.

The movable sub-portion allows the end effector system 302 to be oriented to grasp the object. For example, the radial actuation system 320 may move the end effector system 302 such that the end effector 334 contacts the object. As the radial actuation system 320 moves the end effector system 302 towards the object, the movable sub-portion, including the end effector 334, rotates about an axis of the gimbal assembly (e.g., x′, y′, or z′ axes). The end effector 334 grasps the object when the grasping surface 335 contacts the object, such as when the grasping surface 335 is roughly parallel to a surface of the object to be grasped.

FIG. 3H further shows the self-alignment mechanism cup 362 engaged with the self-alignment mechanism cone 364 as previously discussed in relation to FIGS. 3A and 3B. The radial actuation system 320 moves the self-alignment mechanism cup 362 in relation to the self-alignment mechanism cone 364. A first feature or surface coupled to the end effector 334, such as an inner surface 363 of the self-alignment mechanism cup 362, contacts a second feature or surface coupled to the end effector 334, such as an outer surface 365 of the self-alignment mechanism cone 364, when the shaft 324 is retracted. The support legs 366 are coupled to the first surface and the end effector 334, and transfer movement of the first surface to the end effector 334. As the radial actuation system 320 moves the self-alignment mechanism cup 362 towards the self-alignment mechanism cone 364, the inner and outer surfaces 363 and 365 maintain contact and align the movable sub-portion of the end effector system 302 with the fixed sub-portion. The inner and outer surfaces 363 and 365 are an angled surface, and in particular, are at an obtuse angle as measured from the shaft 324 to the inner surfaces 363 or to the outer surface 365. In the embodiment depicted in FIG. 3H, the end effector system 302 is aligned and in the first position.

A gap is shown between self-alignment mechanism cone and cup 364 and 362 for illustrative purposes. The gap in the end effector system 302 would be smaller and sized to allow the outer surface of the self-alignment mechanism cone 364 to mate with the inner surface of the self-alignment mechanism cup 362 when in the first position. In some embodiments, the mating of the self-alignment mechanism cone and cup 364 and 362 may align the coordinate system of the gimbal assembly (e.g., x′, y′, and z′ axes) to the coordinate system of the system 300 (e.g., x, y, and z axes).

Returning to the discussion in relation to FIGS. 3H and 3I, the position limiters 354 of the gimbal housing 342 may limit a range of rotation of the gimbal assembly 340 and end effector 334. As the movable sub-portion rotates, the support legs 366 move and contact the position limiters 354, which remained fixed with the rest of the fixed sub-portion. Thus, the position limiters 354 constrain the rotation of the gimbal assembly 340, by limiting the rotation about the x and z axes of the system 300.

The end effector 334 forms a plurality of channels 336 within. Each channel 336 of the plurality of channels 336 includes an opening 337 formed in the grasping surface 335. The channels 336 of the end effector 334 include a first subset 336A and a second subset 336B. The first subset 336A is fluidly coupled to the first vacuum port 339A and the second subset 336B is fluidly coupled to the second vacuum port 339B. The separate subset-vacuum port combinations allow independent control of the vacuum for each of the subsets 336A and 336B of the channels 336. For example, the second subset 336B may pull a stronger vacuum (e.g., having a lower Torr value) than the first subset 336A. The first subset 336A may pull a stronger vacuum than the second subset 336B. In some embodiments, only one of the subsets 336A and 336B pull a vacuum. For example, in the embodiment depicted in FIG. 3I, which shows the end effector system 302 grasping an object (e.g., the stringer 118), only the second subset 336B pulls a vacuum because the openings 337 of the first subset 336A do not contact the object. Although the end effector 334 is shown in FIG. 3I as grasping flanges of the stringer 118, in some embodiments, the end effector 334 may be sized to grasp the stringer 118 by a channel formed between the flanges.

In some embodiments, the openings 337 may form different patterns on the grasping surface 335, such as a grid pattern, such as a circular or spiral pattern, such as another shape, such as a pattern having more dense areas of opening 337 than others (e.g., the first subset 336A may have more openings 337 than the second subset 336B and vice versa), such as a random pattern.

In some embodiments, the end effector 334 includes a mechanical gripper instead of, or in addition to, the channels 336 and openings 337. The mechanical gripper may include articulable members, such as grippers or a claw, which may be actuated to grasp objects. In some embodiments, the end effector 334 includes an electrostatic gripper instead of, or in addition to, the channels 336 and openings 337. The electrostatic gripper may include an electroadhesive pad having electrodes to generate alternate positive and negative charges to grasp objects. In some embodiments, the end effector 334 includes a needle gripper instead of, or in addition to, the channels 336 and openings 337. The needle gripper may include a needle or plurality of needles to penetrate a surface of and grasp an object. The needles may be articulable and move toward and away from the object or move in and out of the end effector 334. In some embodiments, the end effector 334 includes an electromagnetic or magnetic gripper instead of, or in addition to, the channels 336 and openings 337. The electromagnetic or magnetic gripper may include an electromagnet or permanent magnet to grasp magnetic or metallic objects.

FIG. 3J depicts a cross-sectional view of the end effector system 302 in a retracted position, according to some embodiments. In particular, FIG. 3J shows an embodiment of the end effector system 302 having a self-alignment mechanism cup 376 and a self-alignment mechanism cone 378.

An inner surface 377 of the self-alignment mechanism cup 376 is a concave surface and an outer surface 379 of the self-alignment mechanism cone 378 is a convex surface. The first feature or surface coupled to the end effector 334 is the inner surface 377. The second feature or surface of the end effector 334 is the outer surface 379. The self-alignment mechanism cup and cone 376 and 378 function similar to the self-alignment mechanism cup and cone 362 and 364 and the concave surface (e.g., the inner surface 377) engages the convex surface (e.g., the outer surface 379) to align the end effector system 302 in the first position.

While a cup and a cone are discussed in relation to FIGS. 3A-3J, any geometry may be used for the first and second alignment features, as long as the first and second alignment features (e.g., the inner and outer surfaces 377 and 379) include mating features to align the end effector system 302.

FIGS. 3K and 3L depict cross-sectional views of the end effector 334 from FIG. 3H, according to some embodiments. In particular, FIG. 3K shows the first subset 336A of channels 336 connecting the openings 337. The end effector 334 and vacuum manifold 338 are not shown as cross-hatched for simplification of illustration.

The first subset 336A is a rectangular, grid-shaped network of channels 336 with each opening 337 connecting to surrounding openings 337 through the channels 336. For example, the first subset 336A connects each opening 337 on a perimeter of the grid to three other openings 337, or two other openings 337 if the opening 337 is at one of four corners of the grid. Openings 337 that are not on the perimeter of the grid connect to four other openings 337.

The first subset 336A of channels 336 includes a first connection channel 336C that fluidly couples the openings 337 to the first vacuum port 339A. The first connection channel 336C is fluidly coupled to a central location of the first subset 336A, which may beneficially ensure an evenly distributed vacuum is pulled through the first subset 336A. In some embodiments, the first connection channel 336C may be fluidly coupled to another location, such as along the perimeter of the grid, which may beneficially be easier to manufacture.

FIG. 3L shows the second subset 336B of channels 336 connecting the openings 337, which includes a second connection channel 336D that fluidly couples the openings 337 to the second vacuum port 339B. The second subset 336B is a rectangular, grid-shaped network of channels 336 similar to the grid of the first subset 336A. The grid of the second subset 336B surrounds the grid of the first subset 336A as viewed from above (and on the page). The second subset 336B of channels 336 are fluidly coupled to the second connection channel 336D at a central location.

Although FIGS. 3H-3I and 3K-3L depict the channels 336 as a rectangular, grid-shaped network that connects the openings 337, in some embodiments the openings 337 may form different patterns on the grasping surface 335. For example, the openings 337 may form a circular or spiral pattern, or another shape, such as a pattern having areas of more openings 337 than others (e.g., the first subset 336A may have more openings 337 than the second subset 336B and vice versa). In some embodiments, the openings 337 may form a random pattern. In some embodiments, the channels 336 may not connect each opening 337 to the surrounding openings 337. For example, if the pattern is a spiral pattern, the channels 336 may only connect the openings 337 along the spiral pattern or path.

In some embodiments, the channels 336 connect all the openings 337 through one vacuum port 339. In such embodiments, there are no subsets of channels 336. In some embodiments, the channels 336 may include more than two subsets of channels 336, which beneficially allows control of additional (e.g., more than two) zones or regions of openings 337.

### Example Positioning of End Effector Systems

FIGS. 4A-4D depict different views of the system 300, according to some embodiments. The tracks 370 and 374, rack gear 372, actuation systems 320 and 326, and parts of the end effector systems 302 other than the end effectors 334 are not shown for illustrative purposes. Simplified versions of the system 300 components, including the end effectors 334, are shown for illustrative purposes. Although not shown, the end effectors 334 are coupled to the support structure 304.

FIG. 4A depicts a top view of the end effectors 334 (e.g., end effectors 334A-F) in an arrangement on the system 300, according to some embodiments. The system 300 is shown grasping two stringers 118 that are shaped substantially straight and oriented substantially parallel to the ribs 306B (or substantially perpendicular to the longitudinal stiffeners 306A), as viewed from above (on the page). The arrangement of the end effectors 334A-C and 334D-F corresponds to a shape of the stringers 118. For example, the end effectors 334A-C are positioned along the longitudinal stiffeners 306A such that the end effectors 334A-C are arranged in a substantially straight line as viewed from above (on the page). The end effectors 334D-F are similarly positioned along the longitudinal stiffeners 306A.

FIG. 4B depicts a side view of the end effectors 334 and the system 300 from FIG. 3A, according to some embodiments. As discussed in relation to FIG. 4A, the end effectors 334 are arranged in a substantially straight line. Thus, the end effectors 334B and 334C are hidden from view by the end effector 334A. The end effectors 334E and 334F are similarly hidden the end effector 334D.

FIG. 4C depicts a top view of the end effectors 334 in a different arrangement on the system 300, according to some embodiments. The end effectors 334 are shown grasping stringers 418 (e.g., a first stringer 418A and a second stringer 418B). The first stringer 418A is substantially straight, but oriented at an angle (e.g., diagonal) in relation to the ribs 306B as viewed from above (on the page). The end effectors 334A-C are arranged in a pattern that corresponds to a shape and the orientation of the stringer 418A (e.g., diagonal).

The second stringer 418B has a curved shape such that the second stringer 418B travels towards and away from a center rib 306B of the ribs 306B as viewed from above (on the page). The end effectors 334D-F are arranged in a pattern that corresponds to the curved shape of the stringer 418A such that the end effectors 334D and 334F are closer to an outer rib 306B than the end effector 334E.

FIG. 4D depicts a side view of the end effectors 334 from FIG. 4C, according to some embodiments. As discussed in relation to FIG. 4A, the end effectors 334 are arranged to grasp the different shapes and orientations of the stringers 418A and 418B. The end effectors 334A-C are further arranged such that the end effector 334A in the front (as shown on the page) is closer to a corresponding longitudinal stiffener 306A than the end effector 334C in a rear. The end effectors 334D-F are also arranged at different distances from corresponding longitudinal stiffeners 306A. Thus, FIGS. 4C and 4D show the system 300 is versatile enough to grasp objects (e.g., the stringers 118, 418A, and 418B) of different shapes and in different orientations in three-dimensional space.

### Examples of Gimbal Lock Mechanisms

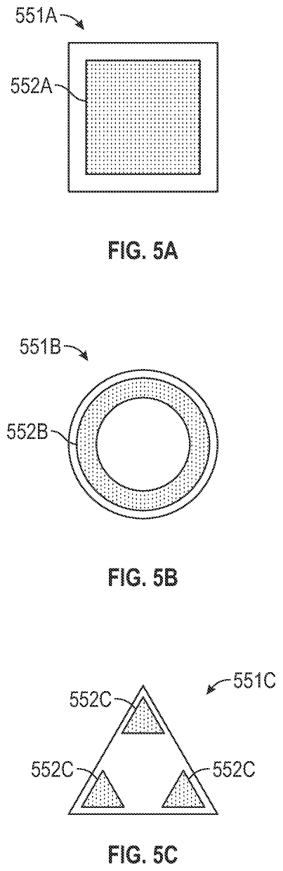

FIGS. 5A-5C depict a bottom view of different gimbal lock mechanisms 551 (e.g., gimbal lock mechanisms 551A-C) for a gimbal assembly 340 (FIGS. 31I-3J), according to some embodiments. The gimbal lock mechanisms 551 may be a plate or other dish, fixture, or surface having a friction material pad or pads 552 (e.g., 552A-C). The friction material pads 552 are brought into contact with the gimbal ball 344 (FIGS. 31I-3J) and a force exerted by the gimbal lock mechanism 551 causes a friction between the friction material pads 552 and the gimbal ball 344, which holds the gimbal ball 344 in place (e.g., prevents the gimbal ball 344 from rotating).

The friction material pads 552 may comprise organic, ceramic, and/or semi-metallic, or metallic material. The friction material pads 552 may also, or alternatively, comprise flexible materials such as neoprene, silicone, nitrile, acrylic, polycarbonate, polyethylene, polyvinyl chloride, acrylonitrile butadiene styrene, and the like. The friction material pads 552 comprising organic material may comprise at least one of rubber, carbon compounds, glass or fiberglass, and para-aramid, and may be bound together with resin. The friction material pads 552 comprising ceramic material may comprise ceramic fibers. The friction material pads 552 comprising semi-metallic material may include between 30% and 70% of a metal (e.g., at least one of copper, iron, steel, and other composite alloys).

FIG. 5A shows a first gimbal lock mechanism 551A having a rectangular or square shape and includes a friction material pad 552A. The friction material pad 552A has a corresponding rectangular or square shape as viewed on the page. A surface of the friction material pad 552A that contacts the gimbal ball 344 may be flat or may have a contour that matches the spherical shape of the gimbal ball 344.

FIG. 5B shows a second gimbal lock mechanism 551B having a circular shape and includes a friction material pad 552B having a torus or “doughnut” shape. A surface of the friction material pad 552B that contacts the gimbal ball 344 may be flat (e.g., all in a same plane) or contoured to match the corresponding surface of the gimbal ball 344.

FIG. 5C shows a third gimbal lock mechanism 551C having a triangular shape and includes friction material pads 552C in corners of the third gimbal lock mechanism 551C. Each of the friction material pads 552C has a triangular shape that aligns with the triangle shape of the third gimbal lock mechanism 551C. A surface of each friction material pads 552C that contacts the gimbal ball 344 may be flat (e.g., all in a same plane) or angled such that the surface of each friction material pad 552C is tangential to the corresponding surface of the gimbal ball 344.

### Examples of Methods for Aligning a Plurality of End Effectors

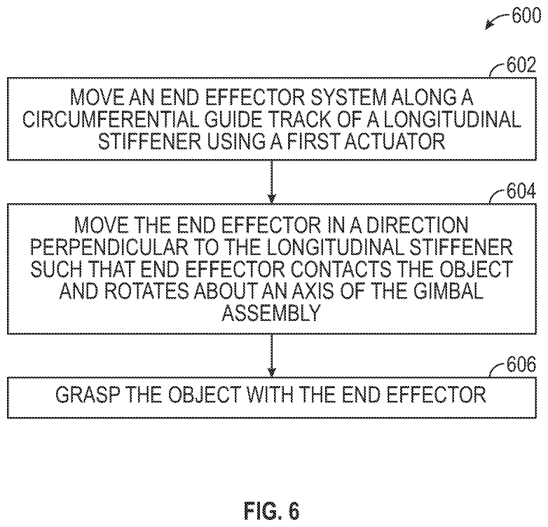

FIG. 6 depicts an example method 600 for aligning a plurality of end effectors of a support structure, according to some embodiments.

Method 600 begins at step 602 with moving an end effector system along a circumferential guide track of a longitudinal stiffener using a first actuator, as described above with respect to FIGS. 2-4D. In some embodiments, the end effector system includes the end effector coupled to a gimbal assembly. The end effector is configured to grasp an object. The gimbal assembly is attached to a shaft. The end effector system further includes a second actuator coupled to the shaft. The second actuator is configured to move the shaft. The end effector system further includes a self-alignment assembly. The self-alignment assembly includes a first surface coupled to the end effector and a second surface coupled to the second actuator. The second surface is configured to interface with the first surface.

Method 600 then proceeds to step 604 with moving the end effector in a direction perpendicular to the longitudinal stiffener such that the end effector contacts the object and rotates about an axis of the gimbal assembly, as described above with respect to FIGS. 3H and 3I.

Method 600 then proceeds to step 606 with grasping the object with the end effector, as described above with respect to FIGS. 1A-4D.

Some embodiments of method 600 further include positioning the end effector using the second actuator to press the first surface against the second surface

Some embodiments of method 600 further include fixing a position of the end effector by pressing a gimbal lock mechanism against a gimbal ball of the gimbal assembly. In some embodiments, the gimbal ball is disposed inside a gimbal housing of the gimbal assembly.

Note that FIG. 6 is just one example of a method, and other methods including fewer, additional, or alternative blocks are possible consistent with this disclosure.

### Example Processing System

FIG. 7 depicts a schematic view of an example system controller 199 (also referred to as the controller 199) that can be used according to the systems and methods described herein. The system controller 199 includes a processor 760 (e.g., a central processing unit (CPU)) in data communication with a memory 750, an input device 770, and an output device 780. Although described separately, it is to be appreciated that functional blocks described with respect to the system controller 199 need not be separate structural elements. For example, the processor 760 and memory 750 is embodied in a single chip. The processor 760 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 760 can be coupled, via one or more buses, to read information from or write information to memory 750. The processor may additionally, or in the alternative, contain memory, such as processor registers. The memory 750 can include processor cache, including a multi-level hierarchical cache in which different levels have different capacities and access speeds. The memory 750 can also include random access memory (RAM), other volatile storage devices, or non-volatile storage devices. The storage can include hard drives, flash memory, etc. Memory 750 can also include a computer program product embodied on memory 750 comprising code such as a motion system control application 752 that is used to control the end effectors as discussed in relation to FIGS. 1A-4D. The motion system control application 752 may control a robotic arm and circumferential and radial actuation systems. Code may also include an end effector control application 754 that is used to control the grasping of the end effector (e.g., the vacuum source) as discussed in relation to FIGS. 3G-3I. Control applications 752 and 754 may be code that can be executed by processor 760. In various instances, the memory is referred to as a computer-readable storage medium or a non-transitory computer-readable medium. The computer-readable storage medium is a non-transitory device capable of storing information, and is distinguishable from computer-readable transmission media such as electronic transitory signals capable of carrying information from one location to another. The non-transitory computer readable medium includes computer-executable instructions that, when executed by a processing system, cause the processing system to perform a method, as described in relation to FIG. 6, including grasping an object via the end effector. In some embodiments, the method performed by the processing system includes positioning the end effector adjacent to the object via actuation systems. In some embodiments, the method performed by the processing system includes positioning the end effectors based on measurements or readings from an input device 770. Computer-readable medium as described herein may generally refer to a computer-readable storage medium or computer-readable transmission medium.

The processor 760 also may be coupled to an input device 770 and an output device 780 for, respectively, receiving input from and providing output to the system controller 199. Input devices 770 may include, but are not limited to a radial position sensor 798A to detect a position of an end effector system (e.g., the end effector system 202 or 302) in relation to a support structure (e.g., the support structure 204 or 304) as discussed in relation to FIGS. 2 and 3A-3J. A circumferential position sensor 798B may be used to detect a position of an end effector system (e.g., the end effector system 202 or 302) along a guide track (e.g., the circumferential guide track 270, lower circumferential guide track 370, or upper circumferential guide track 374) as discussed in relation to FIGS. 2 and 3A-3G. The radial and circumferential position sensors 798A and 798B may be an encoder (e.g., an optical or magnetic, capacitive, or inductive encoder), a resolver, a potentiometer, an angle sensor, an accelerometer, a gyroscope, an inertial measurement unit, a global positioning system, or a motion detector and the like for determining a position of the end effectors. Suitable output devices 780 include, but are not limited to, the radial and circumferential actuators discussed in relation to FIGS. 2-5C (e.g., the radial actuator 322 and the circumferential actuator 328). Output devices 780 may further include an end effector 734 (e.g., a vacuum source connected to the end effector 234 or 334, mechanical gripper, electrostatic gripper, needle gripper, or magnetic gripper) as discussed in relation to FIGS. 2 and 3A-3L. Output devices 780 may further include the robotic arm 108 as discussed in relation to FIGS. 1A-1C.

Aspects of the present disclosure have been described above with reference to specific embodiments. Persons skilled in the art, however, will understand that various modifications and changes may be made thereto without departing from the broader spirit and scope of the present disclosure as set forth in the appended claims. The foregoing description and drawings are, accordingly, to be regarded in an illustrative rather than a restrictive sense.

### Example Clauses

Implementation examples are described in the following numbered clauses:

Clause 1. An end effector system, comprising an end effector coupled to a gimbal assembly, wherein the end effector is configured to grasp an object; and the gimbal assembly is attached to a shaft; a first actuator coupled to the shaft and configured to move the shaft; and a self-alignment assembly, comprising a first surface coupled to the end effector; and a second surface coupled to the first actuator and configured to interface with the first surface, wherein the first actuator is configured to move the shaft such that the first surface engages the second surface to position the gimbal assembly at a first position.

Clause 2. The end effector system of Clause 1, wherein the gimbal assembly comprises a gimbal ball disposed inside a gimbal housing.

Clause 3. The end effector system of Clause 2, further comprising a gimbal lock assembly configured to engage the gimbal ball to prevent the gimbal ball from rotating about at least one axis of the gimbal assembly.

Clause 4. The end effector system of any one of Clauses 1-3, wherein the first surface is a concave surface.

Clause 5. The end effector system of any one of Clauses 1-4, wherein the second surface is a convex surface.

Clause 6. The end effector system of any one of Clauses 1-5, further comprising a second actuator coupled to a carriage, wherein the second actuator is configured to move the end effector system along a track.

Clause 7. The end effector system of Clause 6, wherein the carriage comprises a brake assembly configured to engage the track to prevent the end effector system from moving along the track.

Clause 8. The end effector system of any one of Clauses 1-7, further comprising a plurality of support legs coupled to the end effector and the first surface.

Clause 9. The end effector system of Clause 8, wherein the gimbal assembly comprises a gimbal housing; and the gimbal housing comprises a plurality of position limiters configured to engage the plurality of support legs to limit movement of the gimbal assembly.

Clause 10. The end effector system of any one of Clauses 1-9, wherein the end effector forms a plurality of channels having a plurality of openings on a grasping surface of the end effector; and the plurality of channels are configured to be fluidly coupled to a vacuum source.

Clause 11. The end effector system of any one of Clauses 1-10, wherein the first actuator is configured to retract the shaft to position the gimbal assembly at the first position and extend the shaft to grasp the object at a second position.

Clause 12. A stringer placement system, comprising a plurality of end effectors supported along a support structure, wherein the support structure comprises a plurality of longitudinal stiffeners, wherein each respective longitudinal stiffener of the plurality of longitudinal stiffeners comprises a lower circumferential guide track and a rack gear; and a gimbal assembly coupled to each respective end effector of the plurality of end effectors, wherein the gimbal assembly is configured to allow the respective end effector to rotate about at least one axis; a radial actuation system coupled to the respective end effector, wherein the radial actuation system comprises a radial actuator; and the radial actuator is configured to move the respective end effector in a direction orthogonal to a respective longitudinal stiffener; a circumferential actuation system coupled to the respective end effector, wherein the circumferential actuation system comprises a circumferential actuator coupled to a pinion gear; and the pinion gear is configured to engage the rack gear of the respective longitudinal stiffener to move the respective end effector along the respective longitudinal stiffener; and a lower carriage assembly configured to movably attach the radial actuation system and the circumferential actuation system to the lower circumferential guide track of the respective longitudinal stiffener.

Clause 13. The stringer placement system of Clause 12, wherein the respective longitudinal stiffener further comprises an upper circumferential guide track; an upper carriage assembly couples the radial actuation system to the upper circumferential guide track; and the upper carriage assembly is configured to move the radial actuation system along the upper circumferential guide track.

Clause 14. The stringer placement system of Clause 13, wherein the upper carriage assembly comprises a plurality of rollers configured to travel along the upper circumferential guide track.

Clause 15. The stringer placement system of any one of Clauses 12-14, further comprising a support structure mount plate configured to mount the support structure to a motion system.

Clause 16. The stringer placement system of any one of Clauses 12-15, wherein the radial actuator is coupled to the gimbal assembly and configured to move the gimbal assembly in a direction perpendicular to the respective longitudinal stiffener.

Clause 17. The stringer placement system of any one of Clauses 12-16, further comprising a self-alignment assembly, wherein the self-alignment assembly comprises a first surface coupled to the respective end effector; the self-alignment assembly comprises a second surface coupled to the radial actuator; and the first surface configured to engage the second surface to align the respective end effector to a first position.

Clause 18. A method of grasping an object using an end effector, comprising moving an end effector system along a circumferential guide track of a longitudinal stiffener using a first actuator, the end effector system comprising the end effector coupled to a gimbal assembly, wherein the end effector is configured to grasp an object; and the gimbal assembly is attached to a shaft; a second actuator coupled to the shaft, wherein the second actuator is configured to move the shaft; and a self-alignment assembly, comprising a first surface coupled to the end effector; and a second surface coupled to the second actuator and configured to interface with the first surface; moving the end effector in a direction perpendicular to the longitudinal stiffener such that the end effector contacts the object and rotates about an axis of the gimbal assembly; and grasping the object with the end effector.

Clause 19. The method of Clause 18, further comprising positioning the end effector using the second actuator to press the first surface against the second surface.

Clause 20. The method of any one of Clauses 18-19, further comprising fixing a position of the end effector by pressing a gimbal lock mechanism against a gimbal ball of the gimbal assembly, wherein the gimbal ball is disposed inside a gimbal housing of the gimbal assembly.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An end effector system, comprising:
an end effector coupled to a gimbal assembly, wherein:
the end effector is configured to grasp an object; and
the gimbal assembly is attached to a shaft;
a first actuator coupled to the shaft and configured to move the shaft; and
a self-alignment assembly, comprising:
a first surface coupled to the end effector; and
a second surface coupled to the first actuator and configured to interface with the first surface, wherein the first actuator is configured to move the shaft such that the first surface engages the second surface to position the gimbal assembly at a first position.

2. The end effector system of claim 1, wherein the gimbal assembly comprises a gimbal ball disposed inside a gimbal housing.

3. The end effector system of claim 2, further comprising a gimbal lock assembly configured to engage the gimbal ball to prevent the gimbal ball from rotating about at least one axis of the gimbal assembly.

4. The end effector system of claim 1, wherein the first surface is a concave surface.

5. The end effector system of claim 1, wherein the second surface is a convex surface.

6. The end effector system of claim 1, further comprising a second actuator coupled to a carriage, wherein the second actuator is configured to move the end effector system along a track.

7. The end effector system of claim 6, wherein the carriage comprises a brake assembly configured to engage the track to prevent the end effector system from moving along the track.

8. The end effector system of claim 1, further comprising a plurality of support legs coupled to the end effector and the first surface.

9. The end effector system of claim 8, wherein:
the gimbal assembly comprises a gimbal housing; and
the gimbal housing comprises a plurality of position limiters configured to engage the plurality of support legs to limit movement of the gimbal assembly.

10. The end effector system of claim 1, wherein:
the end effector forms a plurality of channels having a plurality of openings on a grasping surface of the end effector; and
the plurality of channels are configured to be fluidly coupled to a vacuum source.

11. The end effector system of claim 1, wherein the first actuator is configured to retract the shaft to position the gimbal assembly at the first position and extend the shaft to grasp the object at a second position.

12. A stringer placement system, comprising:
a plurality of end effectors supported along a support structure, wherein the support structure comprises:
a plurality of longitudinal stiffeners, wherein each respective longitudinal stiffener of the plurality of longitudinal stiffeners comprises a lower circumferential guide track and a rack gear; and
a gimbal assembly coupled to each respective end effector of the plurality of end effectors, wherein the gimbal assembly is configured to allow the respective end effector to rotate about at least one axis;
a radial actuation system coupled to the respective end effector, wherein:
the radial actuation system comprises a radial actuator; and
the radial actuator is configured to move the respective end effector in a direction orthogonal to a respective longitudinal stiffener;
a circumferential actuation system coupled to the respective end effector, wherein:
the circumferential actuation system comprises a circumferential actuator coupled to a pinion gear; and
the pinion gear is configured to engage the rack gear of the respective longitudinal stiffener to move the respective end effector along the respective longitudinal stiffener; and
a lower carriage assembly configured to movably attach the radial actuation system and the circumferential actuation system to the lower circumferential guide track of the respective longitudinal stiffener.

13. The stringer placement system of claim 12, wherein:
the respective longitudinal stiffener further comprises an upper circumferential guide track;
an upper carriage assembly couples the radial actuation system to the upper circumferential guide track; and
the upper carriage assembly is configured to move the radial actuation system along the upper circumferential guide track.

14. The stringer placement system of claim 13, wherein the upper carriage assembly comprises a plurality of rollers configured to travel along the upper circumferential guide track.

15. The stringer placement system of claim 12, further comprising a support structure mount plate configured to mount the support structure to a motion system.

16. The stringer placement system of claim 12, wherein the radial actuator is coupled to the gimbal assembly and configured to move the gimbal assembly in a direction perpendicular to the respective longitudinal stiffener.

17. The stringer placement system of claim 12, further comprising a self-alignment assembly, wherein:
the self-alignment assembly comprises a first surface coupled to the respective end effector;
the self-alignment assembly comprises a second surface coupled to the radial actuator; and
the first surface configured to engage the second surface to align the respective end effector to a first position.

18. A method of grasping an object using an end effector, comprising:
moving an end effector system along a circumferential guide track of a longitudinal stiffener using a first actuator, the end effector system comprising:
the end effector coupled to a gimbal assembly, wherein:
the end effector is configured to grasp an object; and
the gimbal assembly is attached to a shaft;
a second actuator coupled to the shaft, wherein the second actuator is configured to move the shaft; and
a self-alignment assembly, comprising:
a first surface coupled to the end effector; and
a second surface coupled to the second actuator and configured to interface with the first surface;
moving the end effector in a direction perpendicular to the longitudinal stiffener such that the end effector contacts the object and rotates about an axis of the gimbal assembly; and
grasping the object with the end effector.

19. The method of claim 18, further comprising positioning the end effector using the second actuator to press the first surface against the second surface.

20. The method of claim 18, further comprising fixing a position of the end effector by pressing a gimbal lock mechanism against a gimbal ball of the gimbal assembly, wherein the gimbal ball is disposed inside a gimbal housing of the gimbal assembly.
